(19) United States
(12) Patent Application Publication
(10) Pub. No.: US 2010/0230190 A1
(43) Pub. Date: Sep. 16, 2010

(54) TRANSPORTATION VEHICLE WITH ECONOMICAL FUEL CONSUMPTION

(76) Inventor: JEN-SHENG LUNG, TAIPEI CITY (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/567,008

(22) Filed: Sep. 25, 2009

(30) Foreign Application Priority Data
Mar. 10, 2009 (TW) 097138046

(51) Int. Cl. B60K 6/32; B60K 6/20

(52) U.S. Cl. 180/65.21; 180/65.31; 903/908

(57) ABSTRACT

A transportation vehicle with economical fuel consumption consumes fuel to generate primary energy. Besides, the transportation includes an electrolytic device and a fuel cell. The electrolytic device is used to decompose water into oxygen and hydrogen gases by using electricity generated from a primary energy of the transportation vehicle. The fuel cell uses the hydrogen gas from the hydrogen inlet pipe as fuel so as to generate electricity, and then an auxiliary energy is produced by the electricity from the fuel cell so as to drive the transportation vehicle. Thus, the present invention saves energy and reduces carbon emission, and the present invention also meets requirements of environmental protection and prevention of energy crisis.

### BACKGROUND OF THE INVENTION

(1) Field of the Invention

The invention relates to a transportation vehicle, and more in particular to a transportation vehicle with economical fuel consumption.

(2) Description of the Prior Art

Because crude oil resources dry up and energy crisis is higher, oil price is also higher and high oil consumption devices do not only cost a fortune but also greenhouse gas is generated due to incomplete fuel combustion. The greenhouse gas may be a much more devastating factor than energy crisis.

Fuel-powered engines are mainstreams of power sources. For example, automobile, trains or airplane are propelled by fuel-powered engines. Oil reserve is limited on earth, and oil is consumed overly so that oil reserve is becoming much scarce. In addition, fuel combustion will bring about waste and leads to environmental pollution and ecological damage.

In the light of this, a variety of ways how to reduce oil consumption are invented and particularly applied in automobiles. Automobiles are the largest group of fuel-consumption apparatus or vehicles. To resolve fuel consumption of automobiles, quite a few new technologies are developed to generate alternate energy such as solar energy vehicles, or electric vehicles. Taiwan Utility Patent M332599 discloses a wind-powered electric vehicle, and however, there are two disadvantages. Firstly, technology described in Taiwan Utility Patent M 332599 is not mature, and vehicles implemented with this technology are not widely available in the market or cost is still high. Secondly, existing fuel-powered vehicles may not be converted to new vehicles with new technology. So, automobile makers are reluctant to invest this fuel-economy technology, and consumers are not willing to purchase this kind of vehicles.

Thus, some newly developed technologies meet consumers' needs in market so that existing fuel-powered vehicles can be directly converted so as to reduce fuel consumption. For example, Taiwan Utility Patents M327923 and M315259 utilize radiator to adjust oxygen molecules in inlet gas so as to improve combustion efficiency. Besides, Taiwan Utility Patents M313170 and M245085 utilize electrolysis to generate and introduce hydrogen and oxygen gases into engine so that hydrogen and oxygen gases are mixed with fuel. Taiwan Utility Patents M304580 and M248908 magnetize fuel so as to improve combustion efficiency, and M295694 magnetizes infra-red throttle oil ball. Taiwan Utility Patents M261597 magnetizes inlet gas so as to increase combustion efficiency. These technologies have been extensively developed so that this is a crowded field of technology. From experiments, the above-described methods are capable of reducing fuel consumption but these methods are not perfect and it is necessary to explore an optimal method.

Furthermore, hybrid electric vehicle is shipped to market, and hybrid electric vehicle can generate electricity by consuming fuel so as to directly feed electricity to an electric motor that drives the vehicle or feed electricity to rechargeable battery. In the light of this, fuel consumption is significantly reduced, and however, how to recharge battery and how to supply electricity should be much more improved. With cost-cutting and improved performance, hybrid electric vehicle may become popular in market.

Therefore, the present invention provides a transportation vehicle with economical fuel consumption so as to overcome the above disadvantages.

### SUMMARY OF THE INVENTION

Accordingly, it is an object of the present invention to provide a transportation vehicle with economical fuel consumption. The transportation vehicle does not only consume fuel to generate primary energy but also utilizes auxiliary energy generated from electricity so that a cogeneration system is formed. Besides, compared with the prior art, the present invention generates electricity in much more efficient way.

The present invention provides a transportation vehicle with economical fuel consumption. The transportation vehicle is driven by primary or auxiliary energy. In addition to a fuel combustion engine, the transportation vehicle includes an electrolytic device, a hydrogen inlet pipe, a fuel cell, and an electric motor.

When the transportation vehicle moves, electricity is generated and supplied to the electrolytic device so as to decompose water into oxygen and hydrogen gases. The hydrogen inlet pipe is used to introduce the hydrogen gas from the electrolytic device.

The fuel cell uses the hydrogen gas from the hydrogen inlet pipe as fuel so as to generate electricity. The electric motor is powered by the electricity from fuel cell so as to produce auxiliary energy to drive the transportation vehicle.

Therefore, according to the present invention, fuel-driven transportation vehicle further includes the electrolytic device and the fuel cell. The transportation vehicle does not only consume fuel to generate primary energy but also utilizes auxiliary energy generated from electricity so that a cogeneration system is formed. Furthermore, compared with the prior art, the present invention generates electricity in much more efficient way. The present invention brings a less damage against environment. Besides, according to the present invention, existing transportation vehicle can be directly converted in an oil-economy and low-cost way. Thus, automobile makers and consumers' are much more willing to embrace this product so as to achieve environmental protection and energy conservation.

### BRIEF DESCRIPTION OF THE DRAWINGS

The present invention will now be specified with reference to its preferred embodiment illustrated in the drawings, in which:

FIG. 1 is a perspective view of a transportation vehicle according to the present invention;

FIG. 2 is a block diagram of the transportation vehicle with a magnetic device according to the present invention; and

FIG. 3 is a perspective view of a magnetic device according to the present invention.

### DESCRIPTION OF THE PREFERRED EMBODIMENT

In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

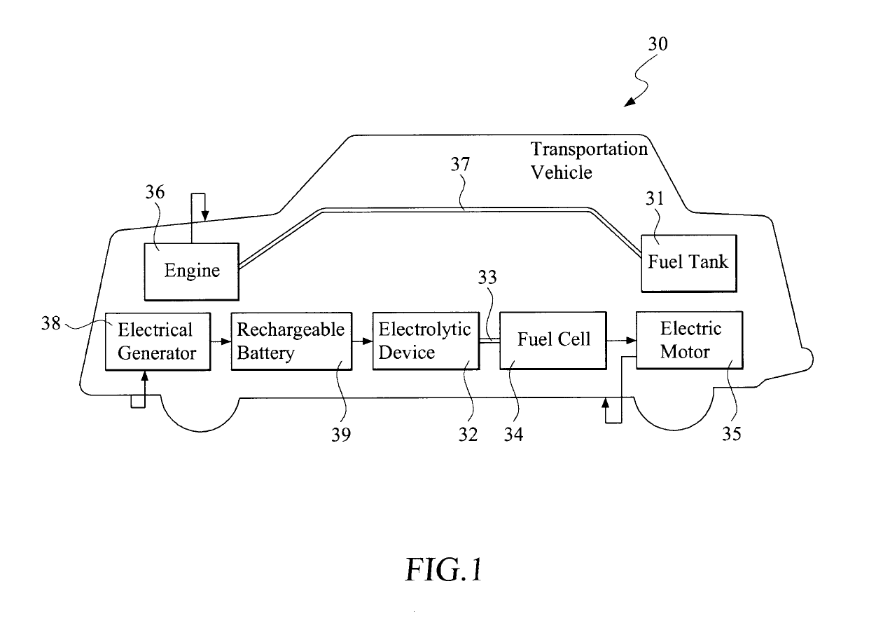

Referring to FIG. 1, it illustrates a perspective view of a transportation vehicle 30 according to the present invention. The present invention relates to the transportation vehicle 30 such as motorcycles, or automobiles which are driven by energy. The transportation vehicle 30 includes an electrolytic device 32, a hydrogen inlet pipe 33, a fuel cell 34, and an electric motor 35.

Water is introduced into the electrolytic device 32, and when the transportation vehicle moves, electricity is generated and supplied to the electrolytic device 32 so as to decompose water into oxygen and hydrogen gases. The hydrogen gas inlet pipe 33 introduces the hydrogen gas from the electrolytic device 32 into the fuel cell 34.

The fuel cell 34 uses the hydrogen gas from the hydrogen gas inlet pipe 33 as fuel so as to generate electricity. When the electric motor 35 is powered by electricity from the fuel cell 34, the electric motor 35 generates auxiliary energy to drive the transportation vehicle 30.

As to electricity supplied to the electrolytic device 32, the transportation vehicle 30 such as automobiles includes an electrical generator 38 and a rechargeable battery 39.

The electrical generator 38 generates electricity when the transportation vehicle 30 moves. The rechargeable battery 39 such as 12-V battery of the automobiles is used to store electricity generated by electrical generator 38.

When the rechargeable battery 39 is charged to a pre-determined volt such as 100% of capacity, redundant electricity will be supplied to the electrolytic device 32. Thus, electricity is not generated by consuming fuel oil, and only redundant electricity helps electrolysis. That is what we called “energy-saving”.

As to fuel oil consumed by the transportation vehicle 30, the transportation vehicle 30 includes a fuel tank 31, an engine 36, and a fuel pipe 37.

The fuel tank 31 is used to store fuel oil, and the fuel pipe 37 is used to introduce fuel oil of the fuel tank 31 into the engine 36. The engine 36 consumes fuel oil to generate a primary energy to drive the transportation vehicle 30.

In practical, when the transportation vehicle 30 such as automobile consumes fuel oil to generate a primary energy to drive the transportation vehicle 30, redundant electricity will be stored or is used to decompose water into hydrogen and oxygen gases. Then, hydrogen and oxygen gases are stored respectively. Until volume of hydrogen gas is stored to pre-determined amount, fuel-consumed system is shut down and the fuel cell 34 and the electric motor 35 are activated to drive the transportation vehicle 38 by auxiliary energy.

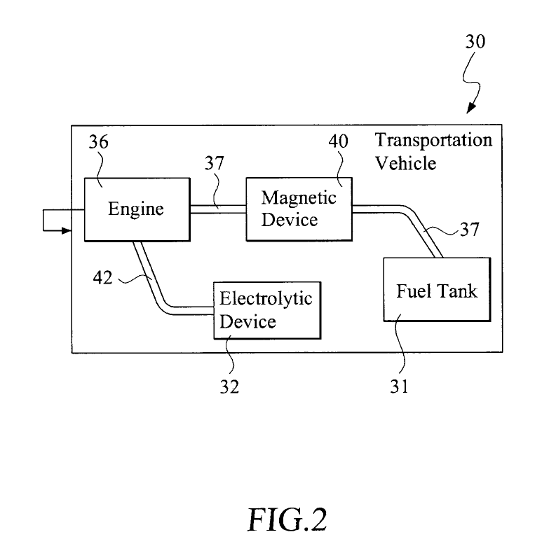

Referring to FIG. 2, it illustrates a block diagram of the transportation vehicle 30 with a magnetic device 40 according to the present invention. The transportation vehicle 30 also includes a magnetic device 40, and an oxygen inlet pipe 42.

The magnetic device 40 is implemented at the fuel pipe 37 so as to magnetize the fuel oil within the fuel pipe 37. Magnetized fuel oil has smaller fuel agglomerates and is prone to be burned, and fuel agglomerates have negative charges because N poles of the magnetic device 40 are in proximity with the fuel pipe 37. These fuel agglomerates with negative charges expel one another and are uniformly distributed so that magnetized fuel oil is perfectly combusted because the magnetized is in contact with support combustion gas. The oxygen inlet pipe 42 is used to introduce oxygen from electrolysis into the engine 36 so as to support combust the magnetized fuel oil. Because of magnetized fuel agglomerates are uniformly distributed, oxygen gas is sufficiently mixed with magnetized fuel agglomerates and fuel combustion is much more perfect and fast. Then, primary energy from fuel combustion is significantly increased. Therefore, the present invention brings a less damage against environment and reduces carbon emission in addition to energy saving and power increase.

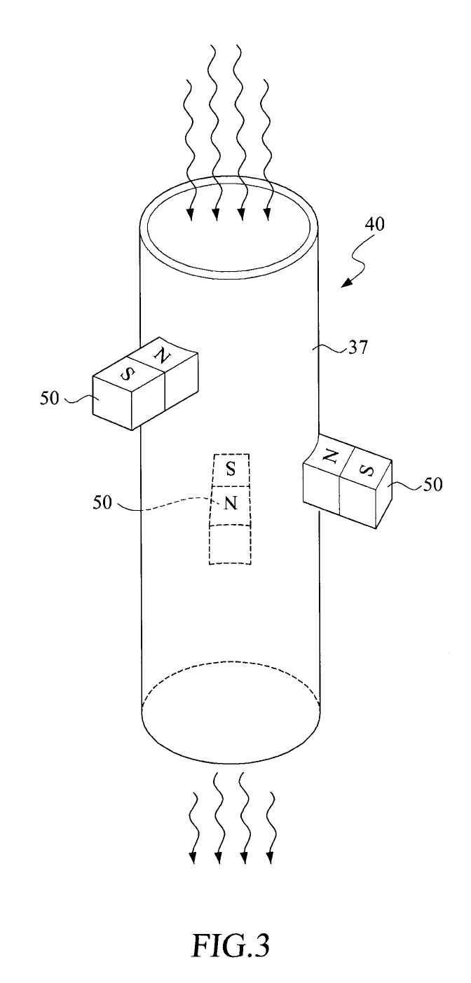

Referring to FIG. 3, it illustrates the magnetic device 40 according to the present invention. The magnetic device 40 of the transportation vehicle 30 includes at least three magnetic objects 50. It is preferred that the magnetic objects 50 are permanent magnets. The magnetic objects 50 are implemented in proximity with perimeter of the fuel pipe 37 and along a helical path. Parts of the magnetic objects 50 with same magnetic pole are oriented toward the fuel pipe 37 so as to magnetize the fuel oil within the fuel pipe 37. In particular, the fuel oil will have negative charges, and it is preferred that inner area in proximity with N pole has negative charges. The magnetic objects 50 are implemented along helical path so that magnetic flux uniformly and helically penetrates through fuel oil within the fuel pipe 37. Thus, optimal magnetic performance is achieved.

Therefore, the present invention provides the transportation vehicle 30 with economical fuel consumption, and the transportation vehicle 30 also includes the electrolytic device 32 and the fuel cell 34. The transportation vehicle 30 does not only consume fuel to generate primary energy but also utilizes auxiliary energy generated from electricity so that a cogeneration system is formed. Compared with the prior art, the present invention generates electricity in much more efficient way. The present invention brings less damage against environment. Besides, existing transportation vehicle can be directly converted in an oil-economy and low-cost way. Thus, automobile makers and consumers' are much more willing to embrace this product so as to achieve environmental protection and energy conservation.

While the present invention has been particularly shown and described with reference to a preferred embodiment, it will be understood by those skilled in the art that various changes in form and detail may be without departing from the spirit and scope of the present invention.

I claim:

1. A transportation vehicle with economical fuel consumption and powered by energy, comprising:
an electrolytic device, used to decompose water into oxygen and hydrogen gases by using a primary electricity generated from a primary energy which is produced when the transportation vehicle moves;
a hydrogen gas inlet pipe, introducing the hydrogen gas from the electrolytic device;
a fuel cell, using the hydrogen gas from the hydrogen gas inlet pipe as fuel so as to generate an auxiliary electricity;
an electric motor, powered by the auxiliary electricity from the fuel cell so as to produce an auxiliary energy to drive the transportation vehicle.

2. The transportation vehicle according to claim 1, further comprising:
an engine, consuming fuel oil to generate the primary energy to drive the transportation vehicle; and
a fuel pipe, used to introduce fuel oil into the engine.

3. The transportation vehicle according to claim 2, further comprising:
a magnetic device, implemented at the fuel pipe so as to magnetize the fuel oil within the fuel pipe; and
an oxygen inlet pipe, used to introduce the oxygen gas from the electrolytic device into the engine so as to support consuming the fuel oil.

4. The transportation vehicle according to claim 3, wherein the magnetic device includes at least three magnetic objects which are implemented in proximity with perimeter of the fuel pipe and along a helical path, and parts of the magnetic objects with same magnetic pole are oriented toward the fuel pipe so as to magnetize the fuel oil within the fuel pipe.

5. The transportation vehicle according to claim 1, further comprising:
an electrical generator, used to generate the primary electricity by using the primary energy generated from the transportation vehicle; and
a rechargeable battery, used to store the primary electricity generated by the electrical generator,
wherein the primary electricity will be supplied to the electrolytic device when the rechargeable battery is charged to a pre-determined of capacity.

6. The transportation vehicle according to claim 1, wherein the transportation vehicle is an automobile.
